(19) United States
(12) Patent Application Publication
(10) Pub. No.: US 2013/0220560 A1
(43) Pub. Date: Aug. 29, 2013

(54) ROLL TYPE BLIND OR SHADE SYSTEM CONFIGURED TO BE EASILY CONVERTED BETWEEN MOTORIZED AND MANUAL OPERATION

(71) Applicants: Willis Jay MULLET, Gulf Breeze, FL (US); Darrin W. BRUNK, Pensacola, FL (US); Richard Scott HAND, Pace, FL (US); Fred C. HIGGINS, Cantonment, FL (US)

(72) Inventors: Willis Jay MULLET, Gulf Breeze, FL (US); Darrin W. BRUNK, Pensacola, FL (US); Richard Scott HAND, Pace, FL (US); Fred C. HIGGINS, Cantonment, FL (US)

(73) Assignee: HOMERUN HOLDINGS CORPORATION, Pensacola, FL (US)

(21) Appl. No.: 13/403,371

(22) Filed: Feb. 23, 2012

(51) Int. Cl. E06B 9/74; E06B 9/68

(52) U.S. Cl. 160/291; 160/311; 160/310

(57) ABSTRACT

There is provided a motorized roller shade that includes a roller shade tube including an outer surface, an inner surface defining an inner cavity, and two end portions. The motorized shade further includes a shade attached to the outer surface of the roller shade tube, a counterbalancing unit configured to provide a counterbalancing force to the shade, and the roller shade tube further comprising substitution configurations to allow the roller shade tube to receive and operate with either a motor assembly or a manual operation assembly.

### FIELD OF THE INVENTION

The invention relates to a roll shade that is configured to be converted between motorized and manual operation. Specifically, the invention relates to a roll shade that is configured to be easily converted between motorized and manual operation including conversion after installation.

### BACKGROUND OF THE INVENTION

A roller shade is a rectangular panel of fabric, or other material, that is attached to a cylindrical, rotating tube. The shade tube is mounted near a header of a window or door such that the shade rolls up upon itself as the shade tube rotates in one direction, and rolls down to cover a desired portion of the window or door when the shade tube is rotated in the opposite direction. Typically roller shades are either manual roller shades or motorized roller shades.

When the roller shade is a manual roller shade, a counter-balance mechanism, clutch type manual operation system and/or the like is used to operate the roller shade. This system allows a user to roll the shade down and be able to maintain the shade down to cover a desired portion of the window or door when the shade is pulled down by a user. The system further allows the user to operate the shade such that it rotates in the opposite direction by the manual system so that the shade rolls up upon itself.

When the roller shade is a motorized system, rotation of the roller shade is accomplished with an electric motor that is coupled to the shade tube. The roller shade may be battery-powered to provide installation flexibility by removing the requirement to connect the motor and control electronics to facility power. The batteries for these roller shades are typically mounted within, above, or adjacent to the shade mounting bracket, headrail or fascia. The motor may be located inside or outside the shade tube, may be fixed to the roller shade support and may be connected to a simple switch. In more sophisticated applications a radio frequency (RF) based system controls the activation of the motor and the rotation of the shade tube. The roller shade typically may include a counter-balance mechanism, such as counter-balance springs, that counter-balance the weight of the shade.

The typical housing for the roller shade is designed either for a manual operation system or a motorized system. The typical manual system cannot be easily removed and replaced with a motor assembly and power source and vice versa without the use of tools, fasteners, controller, wiring, structural modifications, extensive labor and/or the like.

Accordingly, there is a need for a shade that can be configured to be easily converted between motorized and manual operation, including conversion after installation, and does not greatly increase manufacturing complexity and maintenance.

### SUMMARY OF THE INVENTION

Aspects of the invention advantageously provide a motorized roller shade that includes a roller shade tube including an outer surface, an inner surface defining an inner cavity, and two end portions, a shade attached to the outer surface of the roller shade tube, a counterbalancing unit configured to provide a counterbalancing force to the shade, and the roller shade tube further comprising substitution configurations to allow the roller shade tube to receive and operate with either a motor assembly or a manual operation assembly.

Further aspects of the invention advantageously provide a motorized roller shade that includes a roller shade tube including an outer surface, an inner surface defining an inner cavity, and two end portions, a shade attached to the outer surface of the roller shade tube, a counterbalancing unit configured to provide a counterbalancing force to the shade, and substitution configurations associated with the roller shade in order to allow either a motor assembly or a manual operation assembly to move the shade.

Additional aspects of the invention advantageously provide a motorized roller shade that includes a roller shade tube including an outer surface, an inner surface defining an inner cavity, and two end portions, a shade attached to the outer surface of the roller shade tube, a counterbalancing unit configured to provide a counterbalancing force to the shade, the roller shade tube further comprising substitution configurations to allow the roller shade tube to receive and operate with either a motor assembly or a manual operation assembly, wherein the substitution configurations comprise a roller shade tube feature associated with the roller shade tube and at least one of a motor assembly feature and a manual operation assembly feature are configured to interact with one another to form a mechanical connection, and wherein the substitution configurations further comprise at least one of the motor assembly configured to be self-contained and the manual operation assembly configured to be self-contained.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 is a perspective view of an aspect of a roll shade assembly constructed in accordance with aspects of the invention.

FIG. 2 is a perspective view of FIG. 1 showing the roll shade separated from the storage roll assembly and the mounting brackets.

FIG. 3 is a perspective view of the storage roll implemented with a manual configuration with the counterbalance spring and manual control assemblies removed in accordance with aspects of the invention.

FIG. 4 is a perspective view of the storage roll with the manual control assembly replaced by the motorized control assembly constructed in accordance with aspects of the invention.

FIG. 5 is an exploded perspective view of the manual control assembly constructed in accordance with aspects of the invention.

FIG. 6 is an exploded perspective view of the motorized control assembly constructed in accordance with aspects of the invention.

### DETAILED DESCRIPTION

The invention will now be described with reference to the drawing figures, in which like reference numerals refer to like parts throughout. The term “shade” as used herein describes any flexible material, such as a shade, a curtain, a screen, etc., that can be deployed from, and retrieved onto, a storage tube or similar structure.

Generally, the invention relates to a roll type window or door covering system where the coverings are designed to be deployed and stored as part of a manually operated roll shade system having a counterbalanced suspension system. More importantly the window or door covering system is configured to receive a motorized actuator and a power source that can be added or removed at any time after the initial purchase and/or installation to allow motorized operation to control the roller shade. The housing for the window or door covering system is designed such that clutch type manual operation system can be removed and replaced with a motor assembly and power source without the need for tools or fasteners and the power source may be connected to the controller without the need for additional wiring.

There are a number of different approaches to motorized window or door coverings where the coverings, such as a blind or shade, have one or more of an actuator within a housing that holds a gear-reduced motor, a control signal receiver and generator, a counterbalance system, and at least one DC battery where a rotor of the motor is coupled to at least one shaft for raising and lowering the blind or shade to control the amount of solar gain or privacy. In some applications, a control signal generator may generate a control signal for completing the electrical circuit between the battery and the motor. The control signal can be generated in response to a predetermined amount of daylight or in response to a user-generated remote command signal. The actuator can be used to open or close the shade or blind.

In the majority of these cases, the motor and power supply, whether battery or line voltage, is designed into the construction of the unit such that one would need to decide whether to purchase a motorized unit or a manual. Further, not all products have motorized capability. One may have to choose a motorized unit from one manufacturer and a manual unit from another manufacturer if they want both types of products. This is less than desirable as many times the products from different manufacturers do not match in appearance.

The invention is a window or door covering system that may be purchased and installed as a manually operated cordless system and has the capability to easily add a motorized actuator and power supply at a later date; or may be purchased and installed as a motorized system and has the capability to easily modified to be a manual system at a later date. The invention has many benefits including: allowing the window covering unit to be motorized at the factory or any time after installation by installing a motor assembly and power supply; the window covering system can be purchased as a manually operated system and can be easily and quickly upgraded to a motorized system by inserting a motor unit and batteries; the motor unit and power supply can be quickly and easily moved from one window covering system to another window covering system as desired; the motor unit contains the motor controls and an RF receiver for remote control of the window covering system to which it is attached; a motorized shade may be easily converted to a manual shade; and so on.

The advantages of the invention over the prior art may include one or more of: a user can purchase either manually operated or motorized covering systems as needed or can afford and can add or change the system's operational features as needed; a motor and power supply may be removed from one unit and placed into another unit in the field quickly and easily; a user can motorize a unit with RF controls; the invention may not require wiring the unit internally or externally; the invention does not require modifications to the components or additional fasteners to convert from manual to motorized operation; and with the shade being counterbalanced one motor size can be used for multiple size shades.

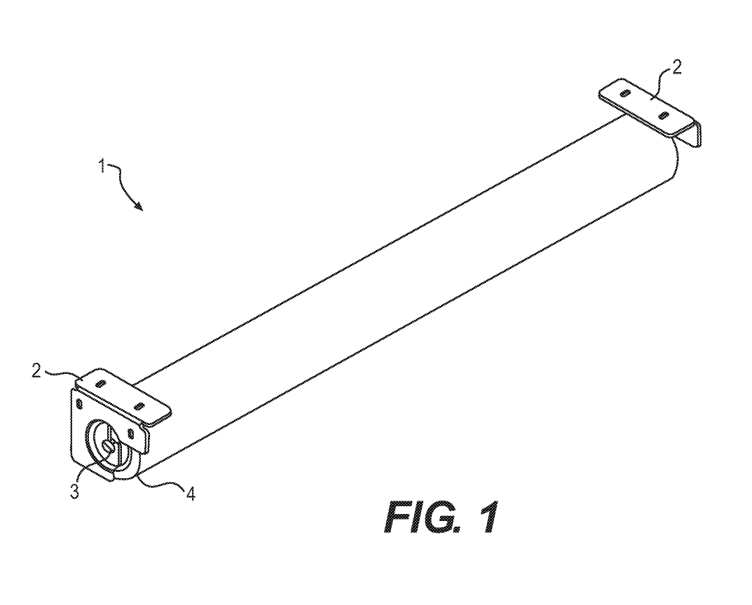

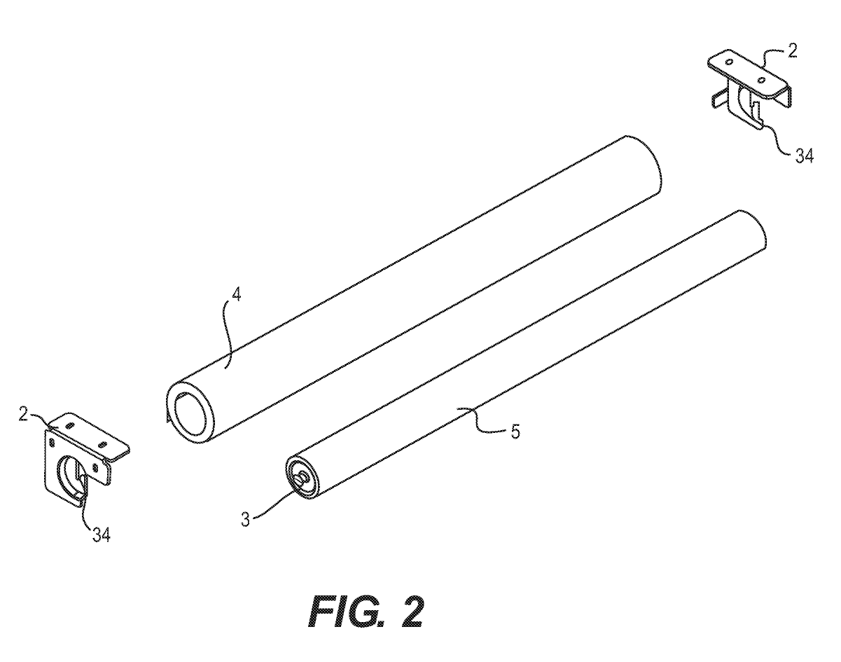

FIG. 1 is a perspective view of an aspect of a roll shade assembly constructed in accordance with aspects of the invention; and FIG. 2 is a perspective view of FIG. 1 showing the roll shade separated from the storage roll assembly and the mounting brackets. In particular, the roller shade assembly 1 may include a storage roll assembly 5 having a roll shade 4 attached to and wound around the storage roll assembly 5. The storage roll assembly 5 may include a shaft 3 on each end thereof (only one is shown). The storage roll assembly 5 and the roll shade 4 may be supported adjacent a window or door by the shafts 3 held in end brackets 2. The end brackets 2 may be attached to structure associated with the window or door. There can also be valances and other coverings as known in the art (not shown) but associated with the roller shade assembly 1. The roller shade assembly 1 may be implemented with a manual control configuration or a motorized control configuration. Moreover, the roller shade assembly 1 may be implemented with a configuration to allow conversion between manual control and motorized control as described in greater detail below.

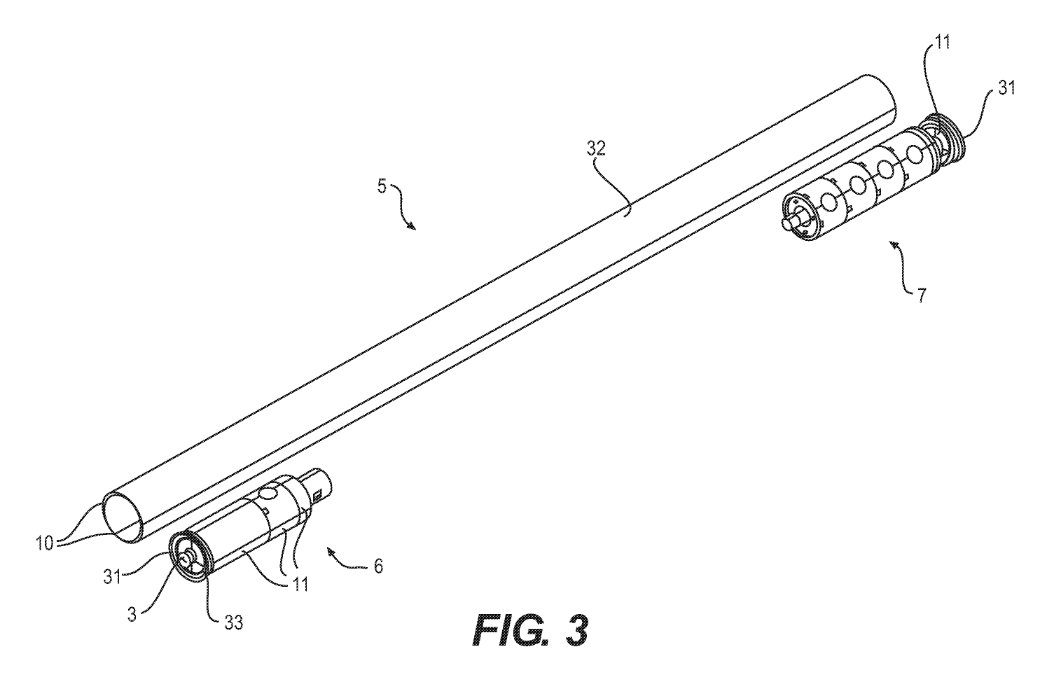

FIG. 3 is a perspective view of the storage roll implemented with a manual configuration with the counterbalance spring and manual control assemblies removed in accordance with aspects of the invention. In the manual control configuration, the storage roll assembly 5 may include a roll tube 32, a manual control system 6, and a counterbalance system 7. The manual control system 6 may include a clutch that may be mechanically coupled to the shaft 3. The counterbalance system 7 may include one or more springs that may be mechanically coupled to the shaft 3 (not shown).

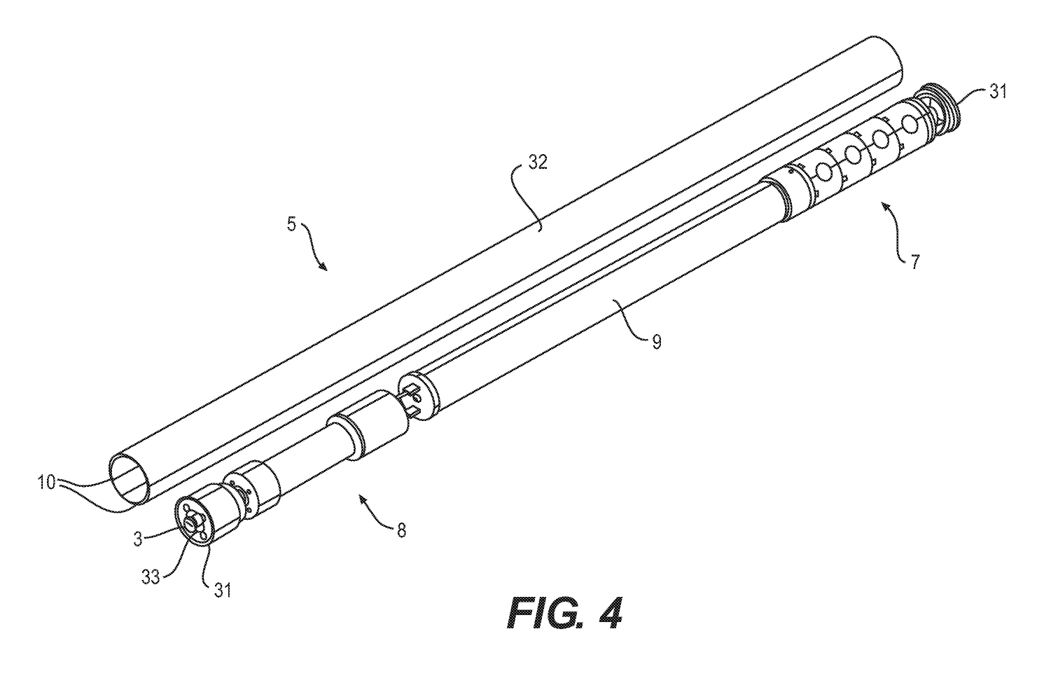

FIG. 4 is a perspective view of the storage roll with the manual control assembly replaced by the motorized control assembly constructed in accordance with aspects of the invention. With respect to FIG. 4, the manual control assembly 6 may be replaced with a motorized control assembly 8 if motorized control of the roll shade assembly 1 is desired.

One or more of the roll tube 32, the manual control system 6, the counterbalance system 7, and the motorized control assembly 8 may include assembly configurations to allow the roll tube 32 to firmly hold the manual control system 6, the counterbalance system 7, and the motorized control assembly 8 in at least one of an axial direction along the roll tube 32 and a radial direction with respect to the roll tube 32. Furthermore, the assembly configurations allow the roll tube 32 to release at least the manual control system 6 for replacement with the motorized control assembly 8 without the use of tools, fasteners, controller, wiring, structural modifications, extensive labor and/or the like.

As shown in FIG. 3 and FIG. 4, the assembly configurations on the roll tube 32 may include at least one groove 10 extending along the inner surface of the roll tube 32. The assembly configurations on the manual control system 6, the counterbalance system 7, and the motorized control assembly 8 may include at least one protrusion 11 mated to fit in the groove 10 of the roll tube 32. The assembly configurations may include any type of component to hold the components together including a slot, a groove, a ring, a lip, an edge, a hole, a slit, a fastener, a clasp, a clip, a catch, a hook, a protrusion, and the like. These assembly constructions prevent the manual control system 6, the counterbalance system 7, and the motorized control assembly 8 from rotating within the roll tube 32. In this regard, the assembly configurations may allow for the construction of these components of the roller shade assembly 1 or the removal of these components of the roller shade assembly 1 without the use of tools, fasteners, wiring, structural modifications, extensive labor and/or the like.

End caps 34 of the manual control system 6, the counterbalance system 7, and the motorized control assembly 8 may also have assembly configurations to hold end caps 34 with respect to the roll tube 32. In this regard, the assembly configurations of the end caps 34 may have a raised ring 31 to limit the depth the assemblies 6, 7 and 8 can be inserted into the roll tube 32. Although specific implementations of the assembly configurations are shown in FIG. 3 and FIG. 4 described above, it is within the scope and spirit of the invention to have other possible assembly configurations. For example, the assembly configurations may include any type of component to hold the components including a slot, a groove, a ring, a lip, an edge, a hole, a slit, a fastener, a clasp, a clip, a catch, a hook, a protrusion and the like.

The output shaft 3 of the manual control system 6 may have a configuration 33 such that when the configuration 33 is mated with the slot 34 in the end bracket 2 it may be prevented from turning. The output shaft 3 may be round and allowed to turn in the end bracket 2. Further, there may be a similar arrangement for the output shaft 3 (not shown) of the counterbalance spring assembly 7.

Each of the manual control system 6, the counterbalance system 7, and motorized control assembly 8 may also include a self-containment configuration. The self-containment configuration allows the entire system (manual control system 6, the counterbalance system 7, or motorized control assembly 8) to be removed from the roller shade assembly 1 as a complete unit. This unit may have all the components to operate. The self-containment configuration with the assembly configurations further simplifies conversion between motorized and manual operation.

In this regard, the manual control assembly 6 may removed by lifting the roll shade 4 and storage roll 5 out of the brackets 2 and sliding the manual control assembly 6 out of the roll shade assembly 1. The assembly configurations and/or self-containment configuration described above make the removal process straightforward in that moving the manual control assembly 6 in a direction parallel with the groove 10 and at least one protrusion 11 allows the manual control assembly 6 and the roll tube 32 to be separated.

Once the manual control assembly 6 is out of the roll tube 32, the motorized control assembly 8 and the power source 9 can then be inserted into the roll tube 32. In a similar manner, the assembly configurations and/or self-containment configuration described above make the insertion and assembly process straightforward in that moving the motor control assembly 8 in a direction parallel with the groove 10 and at least one protrusion 11 allows the motor control assembly 8 and the roll tube 32 to be assembled.

After the motor control assembly 8 and the roll tube 32 are assembled, the storage roll 5 with the roll shade 5 can be placed back in the brackets 2 and the roller shade assembly is now motorized. This process may be reversed to change from motorized operation to manual operation.

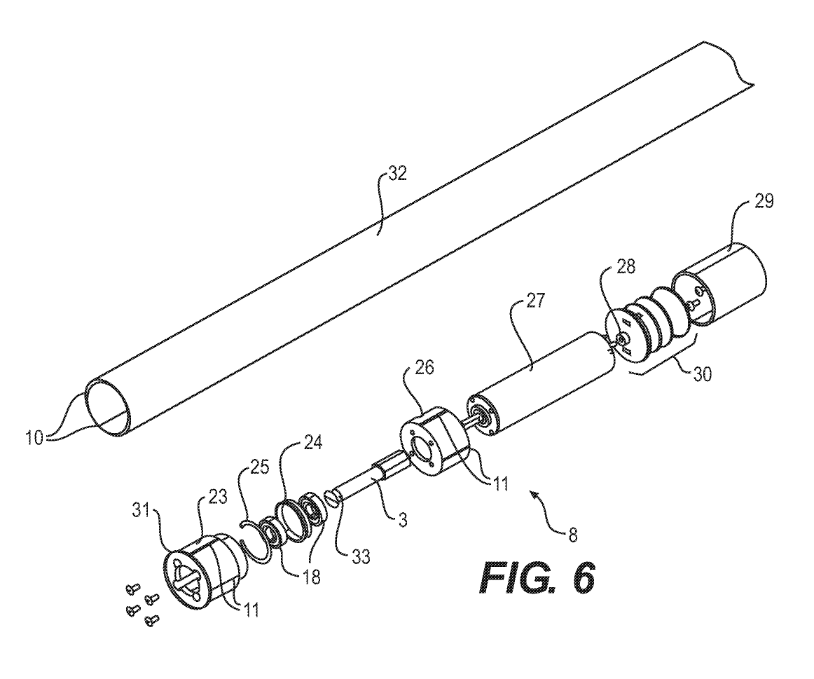

The motorized control assembly 8 may also contain motor controls and a RF receiver on a control board assembly 30 (shown in FIG. 6). With the shade being counterbalanced, the motorizing of the shade assembly 1 may not be greatly affected by the weight or size of the shade therefore one motor size can be used interchangeably for all size shades.

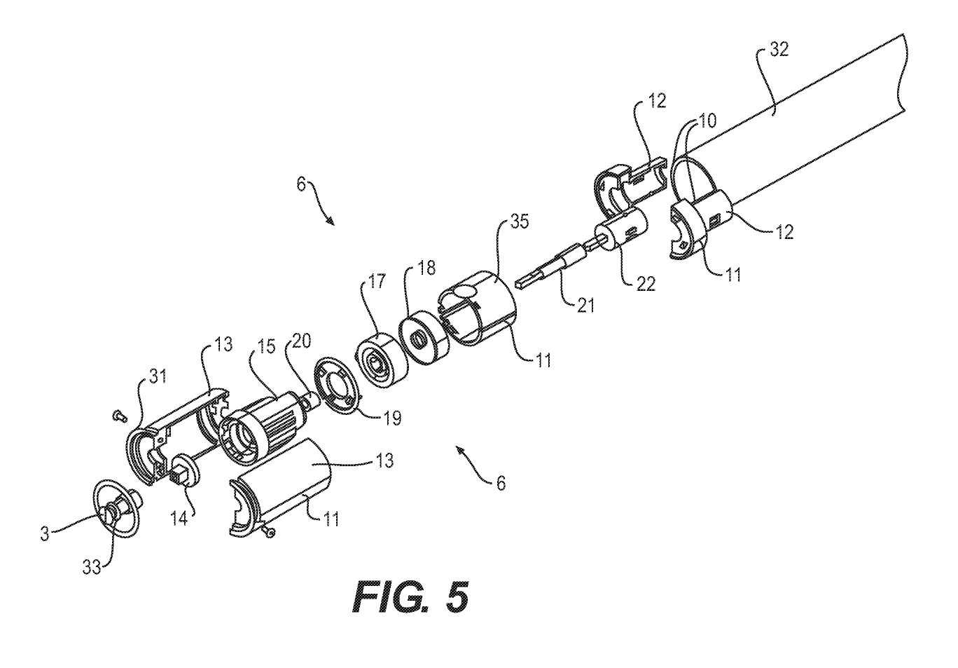

FIG. 5 is an exploded perspective view of the manual control assembly constructed in accordance with aspects of the invention. In particular, as shown in FIG. 5, the manual control assembly 6 may include a counter-counterbalanced spring 17 arranged in a spring case 35, bearing housings 13 and shaft housings 12. The spring case 35 may have protrusions 11 that fit into the grooves 10 of the roll tube 32. Similar protrusions 11 may be arranged on the bearing housings 13 and the shaft housings 12.

Another end of the spring 17 may be secured to a shaft 21. The shaft 21 may be arranged on a spindle 22 and located by the lock collar 20. A connector 14 may connect the shaft 21 to the drive shaft 3. The spring case 35 may include an end portion 19 and a spacer portion 18. A dampener 15 may also be implemented to regulate the movement of the tube 32 allowing a smooth operation and will hold the shade in any position.

FIG. 6 is an exploded perspective view of the motorized control assembly constructed in accordance with aspects of the invention. In particular, the shade or blind can become motorized as noted above. FIG. 6 shows an implementation of the motorized control assembly 8 that may include a bearing housing 23 with bearings 18 and a spacer 24. A clip 25 may be arranged to mechanically hold various components.

The drive shaft 3 may extend through a housing 26 and be attached to the motor 27. Adjacent the motor 27 may be motor controls 30 and the motor control cover 29. The connection between the motor 27 and the motor controls 30 is shown at 28. The power source 9 that may include batteries in a separate tube. Portions of the motorized control assembly 8 may include protrusions 11 that fit into the grooves 10 of the roll tube 32.

Although the above is a specific implementation of the manual control assembly 6 and the motorized control assembly 8, it is within the scope and spirit to have other implementations.

Accordingly, the shade of the invention as described above in the various exemplary aspects associated with the drawings and broader applications described above can address many size applications without greatly increasing costs and parts inventory and not greatly increasing manufacturing complexity and maintenance.

The motorized roller shade assembly may include other components such as an electrical power connector that includes a terminal that couples to a power supply unit, and power cables that may connect to the circuit board(s) located within the circuit board housing.

In some aspects, two circuit boards may be mounted within the circuit board housing in an orthogonal relationship. Circuit boards generally include all of the supporting circuitry and electronic components necessary to sense and control the operation of the motor, manage and/or condition the power provided by the power supply unit, etc., including, for example, a controller or microcontroller, memory, a wireless receiver, etc. In one aspect, the microcontroller is a Microchip 8-bit microcontroller, such as the PIC18F25K20, while the wireless receiver is a Micrel QwikRadio® receiver, such as the MICRF219. The microcontroller may be coupled to the wireless receiver using a local processor bus, a serial bus, a serial peripheral interface, etc. In another aspect, the wireless receiver and microcontroller may be integrated into a single chip, such as, for example, the Zensys ZW0201 Z-Wave Single Chip, etc. In another aspect, a wireless transmitter is also provided, and information relating to the status, performance, etc., of the motorized roller shade may be transmitted periodically to a wireless diagnostic device, or, preferably, in response to a specific query from the wireless diagnostic device.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A motorized roller shade comprising:
a roller shade tube including an outer surface, an inner surface defining an inner cavity, and two end portions;
a shade attached to the outer surface of the roller shade tube;
a counterbalancing unit configured to provide a counterbalancing force to the shade; and
the roller shade tube further comprising substitution configurations to allow the roller shade tube to receive and operate with either a motor assembly or a manual operation assembly.

2. The motorized roller shade according to claim 1 wherein the substitution configurations comprise a roller shade tube feature associated with the roller shade tube and at least one of a motor assembly feature and a manual operation assembly feature.

3. The motorized roller shade according to claim 2 wherein the roller shade tube feature and at least one of the motor assembly feature and the manual operation assembly feature are configured to interact with one another to form a mechanical connection.

4. The motorized roller shade according to claim 2 wherein the substitution configurations comprise at least one of a slot, a groove, ring, lip, edge, and a protrusion.

5. The motorized roller shade according to claim 2 wherein the substitution configurations further comprise at least one of the motor assembly configured to be self-contained and the manual operation assembly configured to be self-contained.

6. The motorized roller shade according to claim 1 wherein the counterbalancing unit comprises at least one spring.

7. The motorized roller shade according to claim 1 further comprising the motor assembly and the motor assembly comprises at least one of a drive gear, a controller, and a power supply.

8. The motorized roller shade according to claim 1 further comprising the manual operation assembly and the manual operation assembly comprises a clutch.

9. A motorized roller shade comprising:
a roller shade tube including an outer surface, an inner surface defining an inner cavity, and two end portions;
a shade attached to the outer surface of the roller shade tube;
a counterbalancing unit configured to provide a counterbalancing force to the shade; and
substitution configurations associated with the roller shade in order to allow either a motor assembly or a manual operation assembly to move the shade.

10. The motorized roller shade according to claim 9 wherein the substitution configurations comprise at least one of the motor assembly configured to be self-contained and the manual operation assembly configured to be self-contained.

11. The motorized roller shade according to claim 10 wherein the substitution configurations further comprise a roller shade tube feature associated with the roller shade tube and at least one of a motor assembly feature and a manual operation assembly feature.

12. The motorized roller shade according to claim 11 wherein the roller shade tube feature and at least one of the motor assembly feature and the manual operation assembly feature are configured to interact with one another to form a mechanical connection.

13. The motorized roller shade according to claim 11 wherein the substitution configurations comprise at least one of a slot, a groove, ring, lip, edge, and a protrusion.

14. The motorized roller shade according to claim 9 wherein the counterbalancing unit comprises at least one spring.

15. The motorized roller shade according to claim 9 further comprising the motor assembly and the motor assembly comprises at least one of a drive gear, a controller, and a power supply.

16. The motorized roller shade according to claim 9 further comprising the manual operation assembly and the manual operation assembly comprises a clutch.

17. A motorized roller shade comprising:
a roller shade tube including an outer surface, an inner surface defining an inner cavity, and two end portions;
a shade attached to the outer surface of the roller shade tube;
a counterbalancing unit configured to provide a counterbalancing force to the shade;
the roller shade tube further comprising substitution configurations to allow the roller shade tube to receive and operate with either a motor assembly or a manual operation assembly;
wherein the substitution configurations comprise a roller shade tube feature associated with the roller shade tube and at least one of a motor assembly feature and a manual operation assembly feature are configured to interact with one another to form a mechanical connection; and
wherein the substitution configurations further comprise at least one of the motor assembly configured to be self-contained and the manual operation assembly configured to be self-contained.

18. The motorized roller shade according to claim 17 wherein the substitution configurations comprise at least one of a slot, a groove, ring, lip, edge, and a protrusion.

19. The motorized roller shade according to claim 17 wherein the counterbalancing unit comprises at least one spring.

20. The motorized roller shade according to claim 17 further comprising:
the motor assembly and the motor assembly comprises at least one of a drive gear, a controller, and a power supply; and
the manual operation assembly and the manual operation assembly comprises a clutch.
